(19) United States
(12) Patent Application Publication
(10) Pub. No.: US 2025/0384185 A1
(43) Pub. Date: Dec. 18, 2025

(54) SYSTEM AND METHOD FOR LOAD IDENTIFICATION USING RELATIVE RESPONSE RATIO

(71) Applicant: TRYAMBH INNOVATIONS PRIVATE LIMITED, Madhya Pradesh (IN)

(72) Inventor: Piyush CHATURVEDI, Madhya Pradesh (IN)

(73) Assignee: TRYAMBH INNOVATIONS PRIVATE LIMITED, Madhya Pradesh (IN)

(21) Appl. No.: 18/875,935

(22) PCT Filed: Jun. 16, 2023
(86) PCT No.: PCT/IB2023/056248

§ 371 Date: Dec. 17, 2024

(30) Foreign Application Priority Data
Jun. 17, 2022 (IN) 202221034915

(51) Int. Cl. G06F 30/23; G06F 119/14

(52) U.S. Cl. CPC G06F 30/23; G06F 2119/14

(57) ABSTRACT

The present disclosure relates to a system (100) and a method (200) for load identification using relative response ratio (R3) values. The system (100) for identifying load location using R3 values includes two or more sensors (130) attached to a structure (120) to measure a structural response value when a load is applied to said structure (120). The system (100) further includes one or more processors (102) configured to: receive a structural response value measured by each of the two or more sensor(s); determine an R3 value between each pair of the sensors; from a database (110), retrieve simulated R3 values associated with each pair of sensing areas (325) on a digital twin (310) of the structure (120), and determine the location of the load being applied to the structure (120) based on the location associated with the simulated R3 value that is substantially equivalent to the determined R3 value.

### FIELD OF DISCLOSURE

The present disclosure relates to load identification. In particular, the present disclosure relates to a system and a method to identifying the load location using by relative response ratio.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Real-time asset monitoring with the digital twin technology and in-situ sensor data is one of the cutting-edge applications of the industrial internet of things and computer simulations by leveraging the best of both digital and physical worlds. Some applications of real-time asset monitoring systems are in field of real time structural health monitoring, damage assessment and prediction using a physics based digital twin coupled with Industrial Internet of Things (IIOT) based in-situ response sensors. Most of the existing digital twins are based on data-driven approaches, where the historical data collected by the sensors are used to predict the structural parameters. However, such data-driven digital twins are not feasible for real-time asset monitoring, particularly for tasks involving identification of load location and magnitude being applied on structures. Existing solutions that rely on solving the inverse problems are notorious for being ill-conditioned, thereby making them computationally expensive and time-consuming.

Furthermore, existing solutions require a large number of sensors, making them impractical for accurate results. Additionally, model-based methods are sensitive to the accuracy of finite element analysis (FEA) and face difficulties in obtaining similar results from experimental data collected from sensors due to lack of information and operational noise. Although some solutions attempt to improve data resemblance and accuracy using post-processing and FEA model updating techniques, they still require a significant number of in-situ sensors and experimental data.

Additionally, the existing solutions are not well-suited for identifying the location of the applied load on the structure. Most solutions either rely on extensive historical experimental data or are computationally intensive, limiting their practical deployment.

Some solutions utilize pattern recognition combined with Euclidean distance-based similarity searching, but they have drawbacks such as the need for constructing a database of feature vectors and limited scope due to variations in load magnitudes. Such solutions also rely on identifying impact location and force magnitude on a composite panel, but it requires a minimum of four measurement points.

Therefore, there is a need for a solution that overcomes the aforementioned problems.

### OBJECTS OF THE INVENTION

Some of the objects of the present disclosure, which at least one embodiment herein satisfies are listed herein below.

An object of the present disclosure is to provide a system and a method for load identification using relative response ratio (R3) values.

Another object of the present disclosure is to provide a system and a method for identifying location of the load using R3 values.

Another object of the present disclosure is to provide a system and a method for identifying magnitude of the load using R3 values.

Another object of the present disclosure is to provide a system and a method for simulating behaviour of structures under load.

Another object of the present disclosure is to provide a system and a method for real-time monitoring of structures using fewer number of sensors.

Yet another object of the present disclosure is to provide a system and a method for identifying loads applied to complex structures.

The other objects and advantages of the present disclosure will be apparent from the following description when read in conjunction with the accompanying drawings, which are incorporated for illustration of the preferred embodiments of the present disclosure and are not intended to limit the scope thereof.

### SUMMARY

This summary is provided to introduce simplified concepts of a system and method for load identification and localization by using the relative response ration method. This summary is not intended to identify key or essential features of the claimed subject matter, nor is it intended for use in determining/limiting the scope of the claimed subject matter.

In an aspect, a system for identifying load location using relative response ratio (R3) values, the system may include, two or more sensors attached to two or more positions on the surface of the structure to measure the structural response value when the load may be applied to said structure. The system may also include one or more processors configured to receive the structural response value measured by each of the two or more sensors, determine the R3 value between each pair of the two or more sensors. The system may, from the database, retrieve one or more simulated R3 values associated with each pair of sensing areas from the plurality of sensing areas on the digital twin of the structure, the plurality of sensing areas corresponding to the positions of the two or more sensors on said structure, where each of the one or more simulated R3 values are associated with the location based on which said simulated R3 values were calculated. The system may determine the location of the load being applied to the structure based on the location associated with the simulated R3 value that may be substantially equivalent to the determined R3 value.

In an embodiment, to generate the database, the one or more processors may be configured to create the digital twin corresponding to the geometry and one or more boundary conditions associated with the structure and apply a virtual load over plurality of points on a surface of interest (SOI) on the digital twin, where each of the points on the SOI corresponds to the positions on the surface of the structure where the load may be applied. The system may determine the simulated R3 value corresponding to each pair of sensing areas in a plurality of sensing areas on the digital twin, and store the one or more simulated R3 values in the database such that each of the simulated R3 values for the sensing area may be associated with the corresponding position of the point on the digital twin on which the virtual load was applied.

In an embodiment, a simulated structural response value for calculating the simulated R3 may be determined using any or any combination of methods belonging to a group may include finite element analysis, extended finite analysis, meshless methods, boundary element methods, and radial basis functions.

In an embodiment, the simulated R3 values may be determined based on the geometry, one or more boundary conditions, the positions of two or more sensors on the structure and the location upon which the virtual load may be applied.

In an embodiment, the one or more processors may be configured to calibrate the one or more simulated R3 values by correcting for, from said one or more simulated R3 values, the difference between, the R3 value measured by a pair of sensors from the two or more sensors with respect to the load applied at a known location on the surface of the structure, and the simulated R3 value determined for the pair of sensing areas on the digital twin corresponding to the position of the pair of sensors on said structure, wherein the simulated R3 value may be determined for the virtual load applied to the known location on the digital twin.

In an embodiment, the one or more processors may be configured to determine the magnitude of the load applied to the structure based on any one or any combination of the structural response value detected by one of the two or more sensors, a predetermined conversion factor and a stiffness constant.

In an embodiment, the two or more sensors may be configured on the surface of the structure where the response of said structure due to the applied force may be within a predefined sensing range.

In an aspect, a method for load identification and localization using relative response ratio (R3) values may include measuring, by two or more sensors attached to two or more position on the surface of the structure, the structural response value when the load may be applied to said structure. The method may include receiving, by one or more processors, the structural response value measured by each of the two or more sensors. The method may also include determining, by the one or more processors, the R3 value between each pair of the two or more sensors. The method can also include retrieving, from the database by the one or more processors, one or more simulated R3 values associated with the pair of sensing areas from the plurality of sensing areas on the digital twin of the structure, the plurality of sensing areas corresponding to the positions of the two or more sensors on said structure, and where each of the one or more simulated R3 are associated with the location based on which said simulated values were calculated. The method may also include determining, by the one or more processors, the location of the load being applied to the structure based on the location associated with the simulated R3 value that may be substantially equivalent to the determined R3 value.

Various objects, features, aspects and advantages of the present disclosure will become more apparent from the following detailed description of preferred embodiments, along with the accompanying drawing in which like numerals represent like features.

Within the scope of this application, it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIGS. 1A-1B illustrates an exemplary block diagram representation of a system in an embodiment of the present disclosure.

FIGS. 2A-2B illustrate flow diagrams for methods for load identification using R3 values, in accordance with an embodiment of the present disclosure.

FIGS. 3A-3D illustrate exemplary representations of generation of the digital twin for the calculation of the one or more simulated R3 values, in accordance to the embodiments of the present disclosure

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Aspects of the present disclosure relates to a system and a method to identify the location of a load applied to a structure using relative response ratio.

In an aspect, a system for identifying load location using relative response ratio (R3) values, the system may include, two or more sensors attached to two or more positions on the surface of the structure to measure the structural response value when the load may be applied to said structure. The system may also include one or more processors configured to receive the structural response value measured by each of the two or more sensors, determine the R3 value between each pair of the two or more sensors, from the database, retrieve one or more simulated R3 values associated with the pair of sensing areas from the plurality of sensing areas on the digital twin of the structure, the plurality of sensing areas corresponding to the positions of the two or more sensors on said structure, wherein each of the one or more simulated R3 values are associated with the location based on which said simulated R3 values were calculated, and determine the location of the load being applied to the structure based on the location associated with the simulated R3 value that may be substantially equivalent to the determined R3 value.

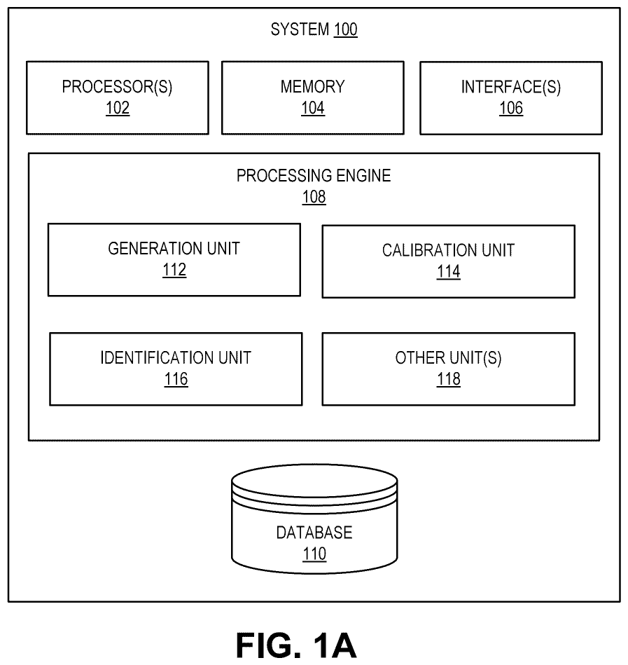

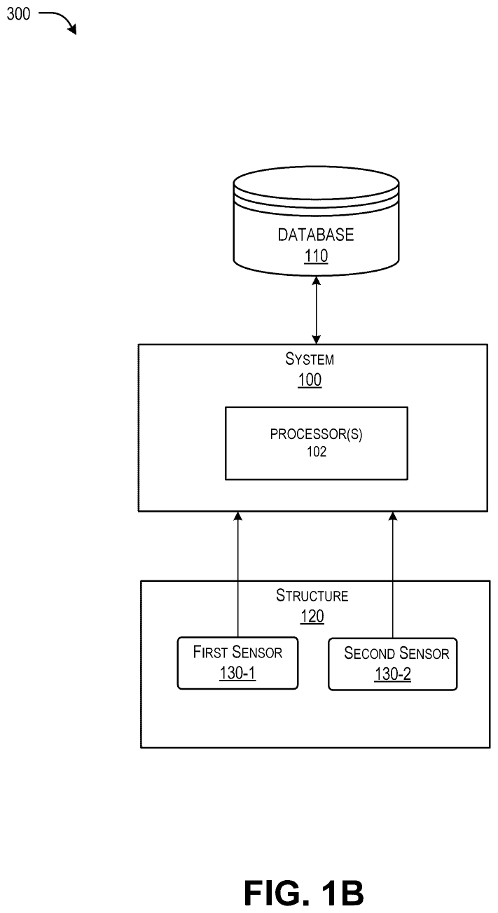

These and other aspects have been explained in further details in conjunction with FIGS. 1A-3D. It may be noted that the said figures are only illustrative, and not to be construed to limit the scope of the present subject matter in any manner.

FIGS. 1A-1B illustrates an exemplary block diagram representation of a system 100 in an embodiment of the present disclosure. The system 100 may be used for identifying location of load applied to a structure 120. In an example, the system 100 may be implemented as any or any combination of hardware-based, software based, or network-based computing device. However, it may be noted that the system 100, may relate to any other system capable of receiving inputs, processing it, and correspondingly providing output based on the received inputs. Such examples would also be covered within the scope of the present subject matter.

In an embodiment, the system 100 for identifying load location using relative response ratio (R3) values may include, two or more sensors 130 attached to two or more positions on the surface of the structure 120 to measure the structural response value when the load may be applied to said structure 120. In an embodiment, the two or more sensors 130 may include, but be limited, displacement sensors, strain gauge rosette sensors, accelerometers, and the like. In an embodiment, the load applied to the structure 120 may be include a force causing the structural response on the structure 120, but not limited to the same.

In and embodiment, the structure 120 may be indicative of any arrangement of integrated elements forming an object or a system. In an embodiment, the structure 120 may include, but not be limited to, buildings, bricks, beams, support structures, scaffoldings, machines, devices or apparatus subjected to stress or force, and the like. In an embodiment, the structure 120 may be indicative of a simply supported beam or a cantilever beam, but not limited to the same.

As depicted in FIG. 1, the exemplary functional units of the system 100 may further include one or more processor(s) 102. The one or more processor(s) 102 can be implemented as one or more microprocessors, microcomputers, microcontrollers, digital signal processors, central processing units, logic circuitries, and/or any devices that manipulate data based on operational instructions. In an embodiment, the one or more processors 102 may be implemented on a single device or in multiple devices. Among other capabilities, the one or more processor(s) 102 are configured to fetch and execute computer-readable instructions stored in a memory 104 of the system 100. The memory 104 can store one or more computer-readable instructions or routines, which may be fetched and executed to create or share the data units over a network service. The memory 104 can include any non-transitory storage device including, for example, volatile memory such as RAM, or non-volatile memory such as EPROM, flash memory, and the like.

In an embodiment, the system 100 can also include an interface(s) 106. The interface(s) 106 may include a variety of interfaces, for example, interfaces for data input and output devices, referred to as I/O devices, storage devices, and the like. The interface(s) 106 may facilitate communication of the system 100 with various devices coupled to the system 100. The interface(s) 106 may also provide a communication pathway for one or more components of the system 100. Examples of such components include, but are not limited to, processing engine(s) 108 and database 110.

In an embodiment, the processing engine(s) 108 can be implemented as a single or a combination of hardware and programming (for example, programmable instructions) to implement one or more functionalities of the processing engine(s) 108. In examples described herein, such combinations of hardware and programming may be implemented in several different ways. For example, the programming for the processing engine(s) 108 may be processor executable instructions stored on a non-transitory machine-readable storage medium and the hardware for the processing engine(s) 108 may include a processing resource (for example, one or more processors), to execute such instructions. In an embodiment, each of the processing engine(s) 108 may be implemented within the system 100. In other embodiments, each of the processing engines 108 may be implemented outside the system 100, where said processing engine(s) 108 may be in communication with the system 100. In an example, the processing engine(s) 108 may be implemented within a centralized computing server (not depicted in FIG. 1), which may be in communication with the system 100 over a network. Such example would also lie within the scope of the present subject matter.

In an example, the machine-readable storage medium may store instructions that, when executed by the processing resource, implement the processing engine(s) 108. In such examples, the system 100 can include the machine-readable storage medium storing the instructions and the processing resource to execute the instructions, or the machine-readable storage medium may be separate but accessible to the system 100 and the processing resource. In other examples, the processing engine(s) 108 may be implemented by electronic circuitry. The database 110 may include data that may be either stored or generated as a result of functionalities implemented by any of the components of the processing engine(s) 108. In an embodiment, the database 110 may be implemented within the system 100 as shown in FIG. 1A. In other embodiments, the database 110 may be implemented outside the system 100, where said database 110 may be in communication with the system 100 as shown in FIG. 1B. In an embodiment, the processing engine(s) 108 may include a generation unit 112, a calibration unit 114, an identification unit 116 and other unit(s) 118. The other unit(s) 118 can implement functionalities that supplement applications or functions performed by the system 100 or the processing engine(s) 108.

In the embodiment, the generation unit 112 may be configured to create the digital twin 310 corresponding to the geometry and one or more boundary conditions associated with the structure 120. In the embodiment, the generation unit 112 may apply the virtual load over plurality of points 320 on the surface of interest (SOI) 315 on the digital twin 310. In an embodiment, the SOIs 315 may be a surface or portions of a surface of the digital twin 310 that correspond to the surfaces or portions of surfaces on the structure 120 upon which the load may be applied.

In an embodiment, each of the points 320 on the SOI 315 corresponds to the positions on the surface of the structure 120 where the load may be applied. In an embodiment, the sensing areas 325 may be indicative of points, group of points or an area on the SOIs 315 from which the simulated structural response values may be generated for calculating the simulated R3 values. In the embodiment, the generation unit 112 may determine the simulated R3 value for each pair of sensing areas 325 on the digital twin 310. Further, in the embodiment, the generation unit 112 may be configured to store the one or more simulated R3 values in the database 110 such that each of the simulated R3 values for the points 320 may be associated with the corresponding position of said points 320 on the digital twin 310 on which the virtual load was applied.

In an embodiment, the generation unit 112 may determine the simulated R3 values based on the geometry, one or more boundary conditions, the positions of two or more sensors 130 on the structure 120 and the location upon which the virtual load is applied. In an embodiment, the generation unit 112 may determine a simulated structural response value for calculating the simulated R3 values, the method comprises using any or any combination of methods belonging to a group comprising finite element analysis, extended finite analysis, meshless methods, boundary element methods, and radial basis functions.

In the embodiment, the calibration unit 114 may be configured to the one or more simulated R3 values, by the one or more processors 102, from said one or more simulated R3 values, the difference between: the R3 value measured by a pair of sensors from the two or more sensors 130 with respect to the load applied at a known location on the one or more points 320 of the structure 120; and the simulated R3 value determined for each pair of sensing areas 325 on the digital twin 310 corresponding to the position of the pair of sensors on said structure 120, wherein the simulated R3 value is determined for the virtual load applied to the known location on the digital twin 310.

In an embodiment, the identification unit 116 may receive the structural response value measured by each of the two or more sensors 130. In an embodiment, the identification unit 116 may determine the R3 value between each pair of the two or more sensors 130. In an embodiment, the identification unit 116 may, from the database 110, retrieve one or more simulated R3 values associated with the pair of sensing areas from the plurality of sensing areas 325 on the digital twin 310 of the structure 120. In an embodiment, the plurality of sensing areas 325 corresponds to the positions of the two or more sensors 130 on said structure 120. Further, each of the one or more simulated R3 values are associated with the location based on which said simulated R3 values were calculated. In an embodiment, the identification unit 116 may determine the location of the load being applied to the structure 120 based on the location associated with the simulated R3 value that may be substantially equivalent to the determined R3 value.

In the embodiment, the simulated R3 values may be determined based on the geometry, one or more boundary conditions, the positions of two or more sensors 130 on the structure 120 and the location upon which the virtual load may be applied.

In the embodiment, the one or more processors 102 are configured to determine the magnitude of the load applied to the structure 130 based on any one or any combination of the structural response value detected by one of the two or more sensors 130, the predetermined conversion factor and the stiffness constant.

In the embodiment, the two or more sensors 130 are configured on the surface of the structure 120 where the response of said structure 120 due to the applied force may be within the predefined sensing range.

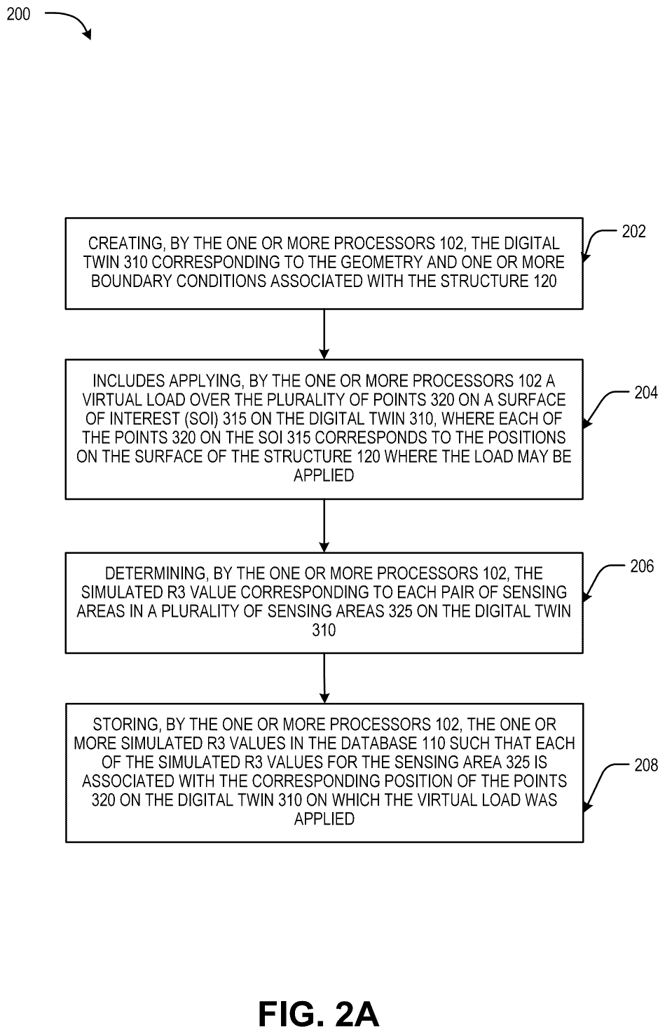

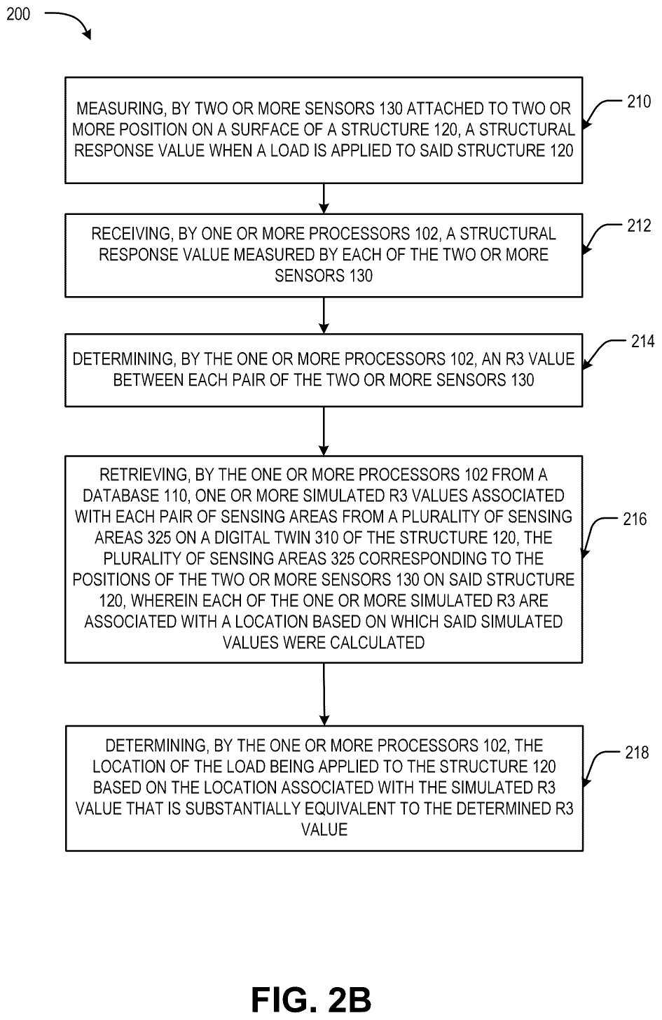

FIGS. 2A-2B illustrate flow diagrams for methods for load identification using R3 values, in accordance with an embodiment of the present disclosure. The method 200 may be implemented within the system 100, as described in conjunction with FIG. 1.

In an embodiment, the method 200 may include steps 202-208 for generating a database of simulated R3 values.

At step 202, the method 200 includes creating, by the one or more processors 102, the digital twin 310 corresponding to the geometry and one or more boundary conditions associated with the structure 120.

At step 204, the method 200 includes applying, by the one or more processors 102 a virtual load over the plurality of points 320 on a surface of interest (SOI) 315 on the digital twin 310, where each of the point 320 on the SOI 315 corresponds to the positions on the surface of the structure 120 where the load may be applied.

At step 206, the method 200 includes determining, by the one or more processors 102, the simulated R3 value corresponding to each point in a plurality of points 320 on the digital twin 310.

At step 208, the method 200 includes storing, by the one or more processors 102, the one or more simulated R3 values in the database 110 such that each of the simulated R3 values for the points 320 is associated with the corresponding position of the points 320 on the digital twin 310 on which the virtual load was applied.

In an embodiment, the method 200 may include steps 210-218 for identifying location of the load using R3 values.

At step 210, the method 200 includes measuring, by two or more sensors 130 attached to two or more position on a surface of a structure 120, a structural response value when a load is applied to said structure 120.

At step 212, the method 200 includes receiving, by one or more processors 102, a structural response value measured by each of the two or more sensors 130.

At step 214, the method 200 includes determining, by the one or more processors 102, an R3 value between each pair of the two or more sensors 130.

At step 216, the method includes retrieving, by the one or more processors 102 from a database 110, one or more simulated R3 values associated with each pair of sensing areas from a plurality of sensing areas 325 on a digital twin 310 of the structure 120, the plurality of sensing areas 325 corresponding to the positions of the two or more sensors 130 on said structure 120, wherein each of the one or more simulated R3 are associated with a location based on which said simulated values were calculated.

At step 218, the method 200 includes determining, by the one or more processors 102, the location of the load being applied to the structure 120 based on the location associated with the simulated R3 value that is substantially equivalent to the determined R3 value.

Further, the method 200 may include calibrating the one or more simulated R3 values, by the one or more processors 102, from said one or more simulated R3 values, the difference between: the R3 value measured by a pair of sensors from the two or more sensors 130 with respect to the load applied at a known location on the one or more surfaces of the structure 120; and the simulated R3 value determined for each pair of sensing areas 325 on the digital twin 310 corresponding to the position of the pair of sensors on said structure 120, wherein the simulated R3 value is determined for the virtual load applied to the known location on the digital twin 310.

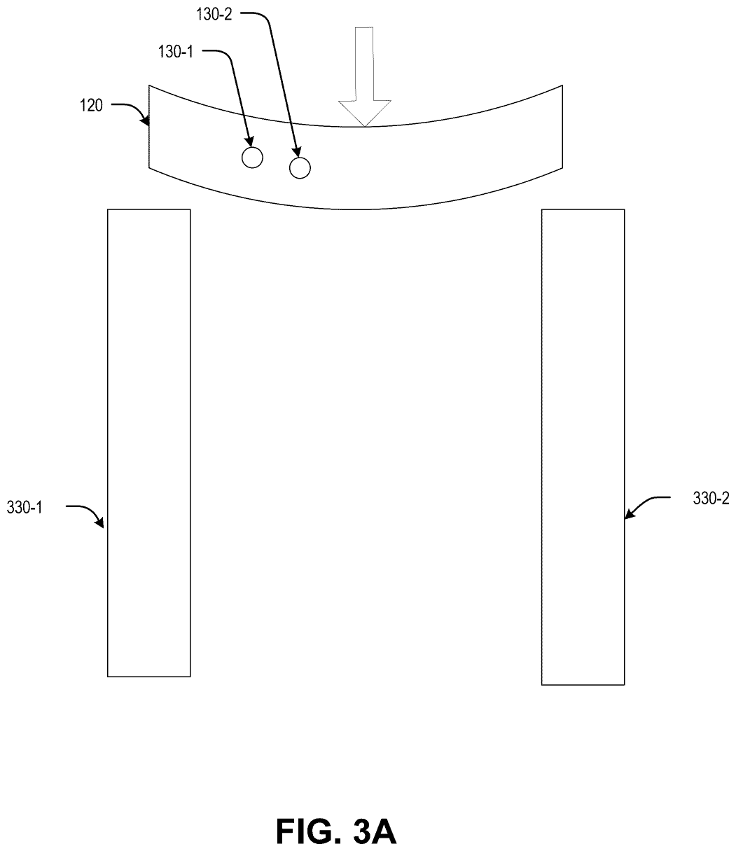

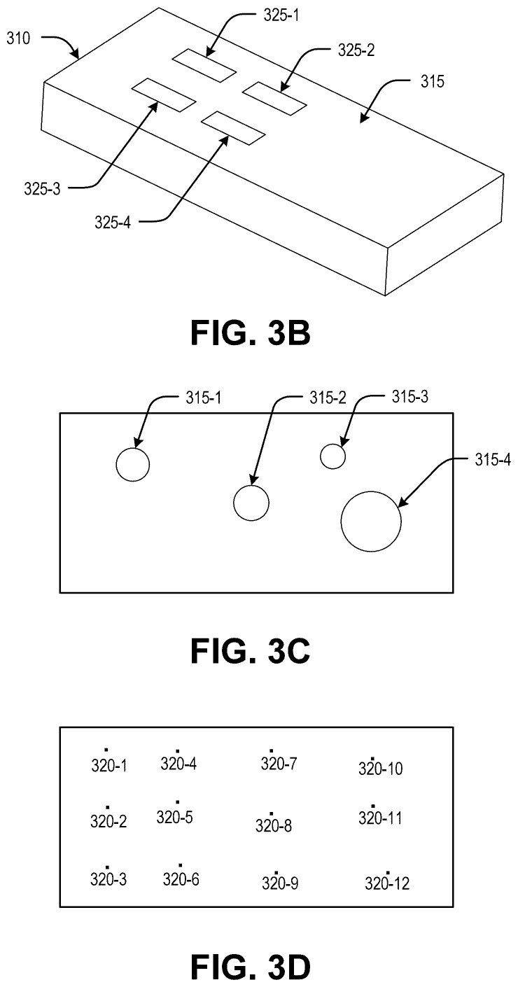

FIGS. 3A-3D illustrate exemplary representations of generation of the digital twin 310 for the calculation of the one or more simulated R3 values, in accordance to the embodiments of the present disclosure.

In an embodiment, the system 100 and the method 200 may be used for identifying the location of the load applied to a structure 120. In an embodiment, the system 100 and the methods may identify the location of the load irrespective of any magnitude. In an embodiment, the simulated R3 values generated may be used to identify the location of the load applied to the structure 120 based on the structural response value measured by the two or more sensors 130 on the surface of the structure 120.

In an embodiment, load applied to the surface of the structure 120 cause structural changes to said structure 120. The structural response may depend upon the magnitude and location of the applied load. The structural response may be indicative of the structural response at several locations based on which the location of the load on the structure 120 may be identified. In an embodiment, the structural response of the structure 120 at a particular location may be expressed as a function of one or more parameters including, but not limited to, magnitude of applied load, location of load, elasticity modulus, material properties, gravitation, structural constraints such as dimensions, support, other loads applied to the structure, and the like. In an embodiment, the equation of structural response may be expressed as

$$R = {F}_{i} \times k \qquad ( 1 )$$

where,
R=response of the structure due to load F,
F=force of load applied on the structure at particular location ‘i’, and
k=conversion factor consisting other constants associated with the structure 120 including, but not limited to stiffness constant.

The equation can be rewritten for the structural response (R′) measured at a different location due to the force ‘F’ at same location ‘i’ under constants (k′) as:

$${R}^{′} = {F}_{i} \times {k}^{′} \qquad ( 2 )$$

Equations 1 and 2 can be rewritten as:

$${F}_{i} = \frac{R}{k} = \frac{{R}^{′}}{{k}^{′}} \qquad ( 3 )$$

Further, equation 3 can be rewritten as:

$$\frac{R}{{R}^{′}} = \frac{k}{{k}^{′}} \qquad ( 4 )$$

Equation 4 indicates that the relative response ratio of the recorded structural response value of the structure 120 for the response measured at two or more locations towards the same applied load may be constant if the factors connecting the applied load and response measured are constant. In an example as shown in FIG. 3A where the structure 120 may be indicative of a simply supported beam of length ‘l’ that is subjected to a load acting at a location that may be ‘a’ meters to the right of support 330-1 and ‘b’ meters to the left of support 330-2, then according to the equations of beam deflection at position ‘x’ from the left support we can write the deflection or vertical displacement of the beam as:

$$D 1 = \frac{F b {L}_{1}}{6 lEI} ( {l}^{2} - {L}_{1}^{2} - {b}^{2} ) \qquad ( 5 )$$

$$and ,$$

$$D 2 = \frac{F b {L}_{2}}{6 lEI} ( {l}^{2} - {L}_{2}^{2} - {b}^{2} ) \qquad ( 6 )$$

Where,
E=Young's Modulus,
I=Moment of Inertia,
l=total length of the beam. The relative ratio of the measured deflection or displacement at locations S1 and S2 may be provided as:

$$\frac{S 1}{S 2} = \frac{D 1}{D 2} = {L}_{1} ( {l}^{2} - {L}_{1}^{2} - {b}^{2} ) / {L}_{2} ( {l}^{2} - {L}_{2}^{2} - {b}^{2} ) \qquad ( 7 )$$

As can be seen in equation (7), R3 values may be independent of the applied load and may be a function of the location of applied load (‘b’) and the position of the displacement sensor on the structure 120 (‘L1 & L2’). In equation (7) if the position of the displacement sensors and other structural parameters are fixed then the associated R3 values may depend upon the location of applied load with respect to the support. Further, the R3 values may be independent of the material properties including, but not limited to, Young's modulus (‘E’), Poisson's ratio, material density, magnitude of applied load, and the like. Hence, the R3 values may be used to locate the applied load.

In an embodiment where the structure 120 may be indicative of a cantilever beam or a simply supported beam, the R3 values can be numerically calculated using equations like in Equation 7. In embodiments where the structure 120 are indicative of complex structures, the system 100 may generate the R3 values determined based on the geometry, one or more boundary conditions, the positions of two or more sensors on the structure and the location upon which the virtual load may be applied. In an embodiment, the simulated R3 values associated with a digital twin 310 may be calculated based on simulated structural response value may be determined using any or any combination of methods including, but not limited to, finite element analysis, extended finite analysis, meshless methods, boundary element methods, and radial basis functions, and the like. The database 110 having the one or more R3 values may then be used to identify the location and magnitude of the applied load on the structure.

As illustrated in FIG. 3B, the system 100 may generate the digital twin 310. In an example, the digital twin 310 may be generated in a virtual environment associated with a computer-aided designing (CAD) system. In an example, for generating the simulated R3 values, the digital twin 310 may be divided into a mesh of elements upon which any one or variation of finite element analysis or variations thereof (FEA) may be performed. In an embodiment, the material properties and boundary conditions associated with the structure 120 may be assigned to the digital twin 310 for implementing methods to generate the simulated R3 values.

In an embodiment, the system 100 may identify the one or more SOIs 315 on the digital twin 310. The SOIs 315 may have the one or more points 320 upon which the virtual load may be applied. In an embodiment, each of the points 320 on the SOI 315 corresponds to the positions on the surface of the structure 120 where the load may be applied. In an embodiment, based on the known properties associated with the structure 120, the system 100 may identify one or more SOIs 315 or no SOI. In an example, the SOI 315 for a structure 120 indicative of a staircase may be the surface corresponding to the upper surface of the structure 120 upon which people may step on and thereby applied load to said upper surface. In such examples, we may consider using sub-surfaces distributed over the SOI 315, in such a way that these sub-surfaces covers the possible limited incidents over the digital twin 310.

In other embodiments where the SOI 315 may be unidentifiable, the system 100 may identify the entire surface of the digital twin 310 as the SOI 315, and the one or more points 320-1 to 320-12 may be distributed over the SOI 315, as illustrated in FIG. 3D.

In embodiments where the digital twin 310 may be meshed for calculating the simulated R3 values, the one or more points 320 may coincide with the nodes associated with the meshes of the digital twin 310. In an embodiment, the system 100 may be optimized to identify the SOI 315 on the digital twin 310 to maximize the efficiency and decrease the effective computational cost while generating the R3 database 110.

In an embodiment, the virtual load may be successively applied to each of the one or more points 320 on the SOI 315. In an embodiment, the one or more points 320 on the SOI 315 may be represented by one or more coordinate values, the coordinate values being associated with the virtual environment on which the digital twin 310 is generated. In an embodiment, the virtual load may be applied to the one or more points 320 to generate the R3 database 110.

In an embodiment, the system 100 may measure the simulated structural response value to calculate the simulated R3 values. In an embodiment, the simulated R3 values may be calculated for each pair of sensing areas 325 on the digital twin 310 whose positions correspond to the two or more positions on which the two or more sensors 130 may be configured on the surface of the structure 120.

In an embodiment, the system 100 may apply a virtual load successively on each of the one or more points 320. In an embodiment, the system 100 may determine the simulated R3 values based on the simulated structural response values between each pair of the one or more sensing areas 325. In an example, finite element analysis may be used to determine the simulated structural response values for calculating the simulated R3 values. In an embodiment, the number of sensing areas 325 distributed on the one or more SOIs 315 may be either less than, equivalent to or greater than the number of sensors 130 attached to the structure 120.

In an embodiment, once the simulated R3 values are generated, the system 100 may store said simulated R3 values in the database 110 along with the corresponding position of the points 320 on the structure 120 on which the virtual load was applied. In an embodiment, the corresponding position of points 320 may be stored as coordinated values associated with said points 320. In an embodiment, the coordinate values may correspond to positions on the surface of the structure 120. In an example, if the ‘i^{th}’ point 320 of the SOI 315 mesh is at a position with coordinates (x,y,z) with respect to the origin of the digital twin 310, then the corresponding simulated R3 values determined for the ‘i^{th}’ point 320 may be assigned to the position of the point 320 having coordinates (x,y,z).

In an embodiment, the two or more sensors 130 may be placed on two or more positions on the surface of the structure 120. In an embodiment, the two or more sensors 130 may be configured to measure the structural response value of the structure 120 when a load is applied thereto. In an embodiment, the two or more positions where the sensors 130 may be configured may correspond to the one or more SOIs 315 on the digital twin 310. In an embodiment, the two or more positions may be selected with an objective to maximize accuracy of the structural response value measured by the two or more sensors 130. In an embodiment, the two or more positions may be indicative of positions on the surface of the structure 120 where the structural response of said structure 120 due to the applied force is within a predefined sensing range.

In an embodiment, the two or more positions on the surface of the structure 120 may be selected based on including the type of sensors 130, but not limited to the same. In an example where the two or more sensors 130 may be indicative of displacement sensors, the two or more positions on the structure 120 may be indicative of positions having deflection within a predetermined deflection range. In such examples, the deflection range may be a numeric range indicative of the maximum estimated deflection of the structure 120 given its geometry, material properties and boundary conditions. In an example where the structure 120 is indicative of a simply supported beam, the two or more displacement sensors may be configured proximate to the centre of the structure 120 as the centre of said structure 120 may have a deflection value within the predetermined deflection range. Likewise in other examples where the structure 120 is indicative of a cantilever beam, the two or more displacement sensors may be configured to the free-hanging edge of the structure 120.

In other embodiments, the two or more sensors 130 may be indicative of strain gauges. In such embodiments, the strain gauges may be configured on positions on the surface of the structure 120, where said structure 120 may have a strain value within a predetermined stress range. In yet other embodiments, the strain gauges may be configured on positions on the structure 120 having fluctuations within a corresponding predetermined range.

In an embodiment, once the database 110 of the simulated R3 values are generated, the system 100 may receive the structural response values received from two or more sensors 130 configured to the structure 120, and determine the R3 values based on the measured structural response values. The system 100 may determine the location of the load on the structure 120 by matching the R3 values with the simulated R3 values in the database 110. In an embodiment, the system 100 may also select pairs of sensors 130 from the two or more sensors 130 to determine the R3 values appropriately based on including, but not limited to, the type of sensors 130, direction of applied load, and the like. In an example where the sensors 130 are indicative of displacement sensors or accelerometer sensors, the direction of the applied load can be assumed with the help of direct sensor data, based on the direction along which there is a sudden spike in the measured quantity. In such examples, the two or more sensors 130 measuring the structural response values along the direction of applied load may be selected, thereby improving accuracy of the system 100.

In an embodiment, since the simulated R3 values are associated with a corresponding point 320 on which the virtual load was applied, the system 100 identifies the location of the load being applied to the structure 120 by matching the closest simulated R3 value to the R3 value determined using the structural response values measured therebefore. The system 100 may also plot R3 values on the corresponding coordinates of points 320 of the SOI 315 to visualize including, but not limited to, trends and features of the distribution of the database 110 for predicting the R3 values of the locations not covered by the one or more points 320 on the SOI 315.

In an embodiment, since the R3 values remain constant for any two positions on the surface of the structure 120, the system 100 may be able to identify the location of the load being applied to the structure 120 by comparing the R3 values with the simulated R3 values. The system 100 may identify the position of the point 320 associated with the simulated R3 values that is substantially equivalent to the R3 values determined from the structural response values received from the two or more sensor 130. In some embodiment, when the SOIs are indicative of portions of surfaces on the digital twin 310 (as shown in FIG. 3C as SOIs 315-1 to 315-4), the location of the load may be identified to be the position associated with a point 320 that is closest to the centre of said SOI 315.

In an embodiment, the magnitude of the load may be determined based on any one or any combination of the including, but not limited to structural response value detected by one of the two or more sensors 130, a predetermined conversion factor and a stiffness constant. The conversion factor may be known as the frequency response function (FRF). In an embodiment, the equation associated with conversion factor may be written as:

$$K = R / F \qquad ( 8 )$$

Where,
R=the structural response value
F=known load or the force
K=conversion factor

Once the conversion factor is determined, the magnitude of the load may be obtained by rewriting the equation 8 as:

$$F = R / K \qquad ( 9 )$$

In an embodiment, the conversion factor may be stored in the database 110 along with the simulated R3 values and the corresponding position of points 320 on which the virtual load was applied to.

In an embodiment, the system 100 may use the conversion factor to determine the magnitude of the load applied to the structure 100. In an embodiment, the system 100 may determine the magnitude of the load based on any one or any combination of including, but not limited to, the structural response value measured by the two or more sensors, the conversion factor stored in the database 110 and a stiffness constant associated with the structure 120. In an embodiment, the system 100 may determine the magnitude of the load applied to the structure 100 by dividing the structural response value by the conversion factor, as shown in equation (9).

### Exemplary Scenario:

The following details an exemplary implementation of the system 100 and the method 200. It may be appreciated by those skilled in the art that the system 100 and the method 200 of the present disclosure may not limited to the following implementation, and that the present disclosure may be suitably adapted and/or implemented using other tools and techniques without deviating from the scope of the present disclosure.

In an example, the system 100 may generate the digital twin 310 using any or combinations of CAD applications and mechanical simulation applications. In an example, the structure 120 may be a simply supported plate, a cantilever beam or any other structure with complex geometries. In an example, the digital twin 310 may be generated using the 3-D modeler modules including Salome_meca, and FREECAD, but not limited to the same. Further, the simulated R3 values may be determined using the solvers including, but not limited to, Salome_meca-Code_Aster FEA solver, Microsoft office EXCEL, Mechanical ANSYS solvers, and the like. The simulated R3 values generated therefrom may be postprocessed using postprocessors including PARAVIEW post processor, but not limited to the same. The system 100 may generated a mesh of each of the digital twins 310 using a plurality of mesh densities and parameters. The elements for the FEA analysis may also be different for each of the solvers such that the differences or variance between the simulated structural response values may be used to mimic noise in the real life scenarios. The system 100 may mesh the digital twins 310 using the NETGEN 1-2-3D method, which may generate a linear mesh consisting of 3D tetrahedral elements. The mesh may allow generation of one or more elements upon which the FEA analysis may be performed for generating the simulated R3 values. In an embodiment, the system 100 may generate a relatively coarse mesh for computational efficiency. In an embodiment, the mesh of points 320, as shown in FIG. 3D may coincide with the nodes from the FEA mesh generated to ensure consistency. In an embodiment, the points 320 of the mesh may or may not need to coincide with the nodes of the FEA mesh. However, it may be appreciated by those skilled in the art that the simulated R3 values may also be generated using solvers that may not require the digital twins to be meshed.

The system 100 may generate the digital twin 310 having the same geometry, boundary conditions and the material properties as the structure 120. The material properties may include, but not limited to, Young's modulus, Poisson's ratio, density and the like. In an example, the system 100 determines boundary conditions (e.g., fixed support, applied load, etc.) for each of the solvers. The boundary conditions should be similar for both the models to ensure that the response of the models is comparable. In an example, the material of the structure 120 may be structural steel or aluminium alloys, but not be limited to the same. The system 100 may then assign the corresponding material properties to the digital twin 310.

The system 100 may then apply a virtual load successively over one or more points 320 on a SOI 315 on the digital twin 310, where each of the point 320 on the SOI 315 corresponds to the positions on the surface of the structure 120 where the load may be applied. In an embodiment, the system 100 may integrate the solvers of the digital twins 310 such that the respective origins and the X, Y and Z axis of each of the FEA solvers coincide with each other

The FEA analysis may be performed by applying a virtual load successively on each of the one or more points 320 distributed on the one or more SOIs 315 identified on the digital twin 310. Further, the one or more points 320 may be distributed across the SOI 315 on the digital twin 310, upon which the virtual load may be applied. In an example, the one or more points 320 may be randomly distributed on the digital twin 310 such that said one or more points cover maximum possible locations of load application.

The finite element analysis method may chosen as static structural with time steps equal to the number of members of the mesh of points over the SOI 315. The simulated structural response value can then be post processed using various data science tools including, but not limited to, Microsoft EXCEL, Python and the like. The simulated structural response value may be used to calculate the simulated R3 values, and store them in the database 110. The simulated R3 values may be generated by taking the ratio between each pair of the one or more sensing areas 325 on the digital twin 310. In other examples, the simulated R3 values may be generated directly by cancelling out parameters associated with determination of the simulated structural response values. The simulated R3 values may be stored in the database 110 along with the position of the points 320 assigned thereto.

Further, in an example, the synthetic data may be generated using the FEA solver of the FREECAD solver. Synthetic data may be generated to test and validate the system 100 or the method 200. The synthetic data may represent structural response values associated with the structure 120 when a load is applied thereto. The results generated by the FREECAD solver may then be postprocessed in PARA VIEW postprocessor to extract the R3 values. The material properties and the boundary conditions may be kept same as the solvers used for generating the simulated R3 values for consistency. In some examples, for validation purposes, the mesh densities and patterns may be kept different to artificially induce some variance in the data generated by both the solvers which can be considered as the noise or difference in the measured and calculated data. In other embodiments, the system 100 and the method 200 may be tested and validated using two or more in-situ sensors 130 configured to the structure 120.

In other embodiments, the R3 values may be determined using measurements of structural response values by the two or more sensors 130 configured to the surface of the structure 120. Measurements from the two or more sensors 130 may be used for inference of the location and magnitude of the load being applied to the structure 120. In most implementations, the system 100 may employ the two or more sensors 130 to obtain measurements from the structural response values to calculate the R3 values therefrom. The system 100 may then determine the location and the magnitude of the load applied to the structure 120 by comparing the R3 values with the simulated R3 values and using the conversion factors associated thereto.

To identify the location of the load, the closest simulated R3 value by value in the database 110 to the R3 value determined from either the synthetic data or the two or more sensors 130 may be retrieved. Further, the position/location of the point 320 associated with application of virtual load may be determined to be the location of the load being applied to the structure 120.

Likewise, the system 100 and the method 200 may be used to determine the magnitude of the load applied to the structure 120 by storing the conversion factor along with the simulated R3 values. The conversion factor may be used along with the R3 values determined by the system 100 to identify the magnitude of the load.

The R3 values may also be validated by applying multiple loads of random magnitude on the same location on the structure 120. Since the R3 values are independent of the magnitude of the load, each of R3 values calculated for each of the loads applied to the same location on the structure 120 must be within a predetermined R3 value range. The range may allow for factoring of noise of the sensors 130, variance in solver methods and/or limitations inherent to the test. However, each of the R3 values must be substantially equivalent. Likewise, the simulated R3 values may also be validated by applying virtual loads of a plurality of magnitudes on a single point 320, and determining whether the simulated R3 values are within the predetermined R3 value range.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### Advantages of the Present Disclosure

The present disclosure provides a system and method for load identification using relative response ratio (R3) values.

The present disclosure provides a system and method that identifying location of the load using R3 values.

The present disclosure provides a system and method that identifying magnitude of the load using R3 values.

The present disclosure provides a system and method that simulating behaviour of structures under load.

The present disclosure provides a system and method for real-time monitoring of structures using fewer number of sensors.

The present disclosure provides a system and method that identifying loads applied to complex structures.

I claim:

1. A system (100) for identifying load location using relative response ratio (R3) values, the system (100) comprises:
two or more sensors (130) attached to two or more positions on a surface of a structure (120) to measure a structural response value when a load is applied to said structure (120); and
one or more processors (102) coupled to a memory (104), the memory (104) having one or more processor-executable instructions, which, when executed, cause the one or more processors (102) to:
receive a structural response value measured by each of the two or more sensors (130);
determine an R3 value between each pair of the two or more sensors (130);
from a database (110), retrieve one or more simulated R3 values associated with each pair of sensing areas from a plurality of sensing areas (325) on a digital twin (310) of the structure (120), the plurality of sensing areas (325) corresponding to the positions of the two or more sensors (130) on said structure (120), wherein each of the one or more simulated R3 values are associated with a location based on which said simulated R3 values were calculated; and
determine the location of the load being applied to the structure (120) based on the location associated with the simulated R3 value that is substantially equivalent to the determined R3 value.

2. The system (100) as claimed in claim 1, wherein to generate the database (110), the one or more processors (102) are configured to:
create the digital twin (310) corresponding to the geometry and one or more boundary conditions associated with the structure (120);
apply a virtual load over plurality of points (320) on a surface of interest (SOI) (315) on the digital twin (310), where each of the points (320) on the SOI (315) corresponds to the positions on the surface of the structure (120) where the load may be applied;
determine the simulated R3 value corresponding to each pair of sensing areas in a plurality of sensing areas (325) on the digital twin (310); and
store the one or more simulated R3 values in the database (110) such that each of the simulated R3 values for the points (320) is associated with the corresponding position of the points (320) on the digital twin (310) on which the virtual load was applied.

3. The system (100) as claimed in claim 1 or 2, wherein a simulated structural response value for calculating the simulated R3 is determined using any or any combination of methods belonging to a group comprising finite element analysis, extended finite analysis, meshless methods, boundary element methods, and radial basis functions.

4. The system (100) as claimed in claim 1, wherein the simulated R3 values is determined based on the geometry, one or more boundary conditions, the positions of two or more sensors (130) on the structure (120) and the location upon which the virtual load is applied.

5. The system (100) as claimed in claim 1, wherein the one or more processors (102) are configured to calibrate the one or more simulated R3 values by correcting for, from said one or more simulated R3 values, the difference between:
the R3 value measured by a pair of sensors from the two or more sensors (130) with respect to the load applied at a known location on the surface of the structure (120);
and the simulated R3 value determined for the pair of sensing areas (325) on the digital twin (310) corresponding to the position of the pair of sensors on said structure (120), wherein the simulated R3 value is determined for the virtual load applied to the known location on the digital twin (310).

6. The system (100) as claimed in claim 1, wherein the one or more processors (102) are configured to determine the magnitude of the load applied to the structure (130) based on any one or any combination of the structural response value detected by one of the two or more sensors (130), a predetermined conversion factor and a stiffness constant.

7. The system (100) as claimed in claim 1, wherein the two or more sensors (130) are configured on the surface of the structure (120) where the response of said structure (120) due to the applied force is within a predefined sensing range.

8. A method (200) for load identification and localization using relative response ratio (R3) values, the method comprising:
measuring, by two or more sensors (130) attached to two or more position on a surface of a structure (120), a structural response value when a load is applied to said structure (120);
receiving, by one or more processors (102), a structural response value measured by each of the two or more sensors (130);
determining, by the one or more processors (102), an R3 value between each pair of the two or more sensors (130);
from a database (110), retrieving, by the one or more processors (102), one or more simulated R3 values associated with a pair of sensing areas from each plurality of sensing areas (325) on a digital twin (310) of the structure (120), the plurality of sensing areas (325) corresponding to the positions of the two or more sensors (130) on said structure (120), wherein each of the one or more simulated R3 are associated with a location based on which said simulated values were calculated; and
determining, by the one or more processors (102), the location of the load being applied to the structure (120) based on the location associated with the simulated R3 value that is substantially equivalent to the determined R3 value.

9. The method (200) as claimed in claim 8, wherein for generating the database (110), the method (200) comprises:
creating, by the one or more processors (102), the digital twin (310) corresponding to the geometry and one or more boundary conditions associated with the structure (120);
applying, by the one or more processors (102) a virtual load over the plurality of points (320) on a surface of interest (SOI) (315) on the digital twin (310), where each of the point (320) on the SOI (315) corresponds to the positions on the surface of the structure (120) where the load may be applied;
determining, by the one or more processors (102), the simulated R3 value corresponding to each pair of sensing areas in a plurality of sensing areas (325) on the digital twin (310); and
storing, by the one or more processors (102), the one or more simulated R3 values in the database (110) such that each of the simulated R3 values for the sensing area (325) is associated with the corresponding position of the point (320) on the digital twin (310) on which the virtual load was applied.

10. The method (200) as claimed in claim 8 or 9, wherein the method (200) comprises determining a simulated structural response value for calculating the simulated R3 values, the method comprises using any or any combination of methods belonging to a group comprising finite element analysis, extended finite analysis, meshless methods, boundary element methods, and radial basis functions.

11. The method (200) as claimed in claim 8, wherein the method (200) comprises determining the simulated R3 values based on the geometry, one or more boundary conditions, the positions of two or more sensors (130) on the structure (120) and the location upon which the virtual load is applied.

12. The method (200) as claimed in claim 8, wherein for calibrating the one or more simulated R3 values, the method (200) comprises correcting for, by the one or more processors (102), from said one or more simulated R3 values, the difference between:
the R3 value measured by a pair of sensors from the two or more sensors (130) with respect to the load applied at a known location on the one or more surfaces of the structure (120);
and the simulated R3 value determined for the pair of sensing areas (325) on the digital twin (310) corresponding to the position of the pair of sensors on said structure (120), wherein the simulated R3 value is determined for the virtual load applied to the known location on the digital twin (310).

13. The method (200) as claimed in claim 8, wherein the method comprises determining, by the one or more processors (102), the magnitude of the load applied to the structure based on any one or combination the structural response value detected by one of the two or more sensors (130), a predetermined conversion factor and a stiffness constant.

14. The method (200) as claimed in claim 8, wherein the two or more sensors (130) are configured on the surface of the structure (120) where the response of said structure (120) due to the applied force is within a predefined sensing range.
